(19) United States
(12) Patent Application Publication
(10) Pub. No.: US 2015/0371327 A1
(43) Pub. Date: Dec. 24, 2015

(54) SYSTEM FOR DYNAMICALLY SELECTING A COMMUNICATIONS FABRIC

(71) Applicant: London Stock Exchange Group, plc, London (GB)

(72) Inventors: Moiz Kohari, Telluride, CO (US); Eric Baur, Marlborough, MA (US); Gregory Haskins, Holden, MA (US); Alex Tsariounov, Livermore, CO (US)

(21) Appl. No.: 14/309,479

(22) Filed: Jun. 19, 2014

(51) Int. Cl. G06Q 40/04

(52) U.S. Cl. CPC G06Q 40/04

(57) ABSTRACT

In an aspect of the subject matter, a system dynamically selects a communication fabric for use with a trading exchange platform. The system includes a gateway executing on the trading exchange platform, and a client side library executing on a customer device that interacts with application programs executing on the customer device. The gateway and customer device communicate during an initial session over an out-of-band network to select a communication fabric (e.g., InfiniBand, etc.) of one or more communications fabrics available to the customer device. The client side library communicates with the gateway to establish a transaction session over an in-band network utilizing the selected communication fabric. The library then allows the customer device to perform transactions with the gateway of trading exchange platform through the gateway during the transaction session and over the in-band network utilizing the selected fabric.

### BACKGROUND OF THE INVENTION

1. Field of the Invention

The subject matter herein relates to trading exchange platforms and, more specifically, to a system for dynamically selecting a communication fabric for use with a trading exchange platform.

2. Background Information

Customers of a trading exchange typically use application software that is resident on a customer device to participate in transactions directed to the trading exchange over a network. The application software uses industry standard application program interfaces (APIs) to communicate with the trading exchange over a predefined communication fabric. Presently, the customer application software is written to utilize a TCP/IP interface over an Ethernet communication fabric to communicate with the trading exchange over a network.

The Ethernet communication fabric may, at particular times, expose the customers to sources of non-deterministic trade execution times which are independent of the behavior of the rest of the trading software. New or different communications fabrics can reduce or eliminate this non-determinism, but current APIs require customer application software to be rewritten to use each API.

### SUMMARY

A system for dynamically selecting a communication fabric, for use with a trading exchange platform that is associated with a stock exchange, allows customers to perform specific transactions, such as, c new orders (such as buying or selling stock) using messages transmitted over the selected communication fabric. The system includes a gateway executing on the trading exchange platform, and a client side library executing on a customer device that interacts with application programs executing on the customer device. Illustratively, the gateway and customer device communicate during an initial session over an out-of-band (OOB) network to authenticate the customer device and also to negotiate and select a communication fabric, (e.g., InfiniBand, etc.) from one or more communication fabrics available to the customer device, for use during a transaction session. The client side library then communicates with the trading exchange platform through the gateway to establish the transaction session over an in-band network utilizing the selected communication fabric. During the transaction session, the client side library facilitates the formatting and transporting of messages associated with a request issued by the customer device to the trading exchange platform, such that the messages conform to syntax and other requirements of the selected communication fabric.

Advantageously, the system allows application software, executing on the customer device, to communicate with the trading exchange platform over the dynamically selected communication fabric in a manner that is transparent to the customer application program. Thus, there is no need for the underlying customer application program to be customized based on the communication fabric being leveraged by the customer application program. Further, without re-writing the underlying customer application program, customers may execute transactions on a “low-latency” communication fabric in a highly deterministic and real-time or nearly real-time fashion, as appropriate, based on the selection of a remote direct memory access (RDMA) communication fabric.

### BRIEF DESCRIPTION OF THE DRAWINGS

The above and further advantages of the subject matter herein may be better understood by referring to the following description in conjunction with the accompanying drawings in which like reference numerals indicate identically or functionally similar elements, of which:

The invention description below refers to the accompanying drawings, of which:

FIG. 1 is a schematic block diagram of a trading exchange environment;

FIG. 2 is a schematic block diagram of a gateway;

FIG. 3 is a schematic block diagram of a customer device;

FIG. 4 is a flowchart detailing the steps of a procedure for dynamically selecting a communication fabric;

FIG. 5 is a flowchart detailing the steps of a procedure for dynamically selecting a communication fabric for a customer device requesting a particular fabric; and

FIGS. 6A and 6B are schematic block diagrams of a trading exchange environment.

### DESCRIPTION

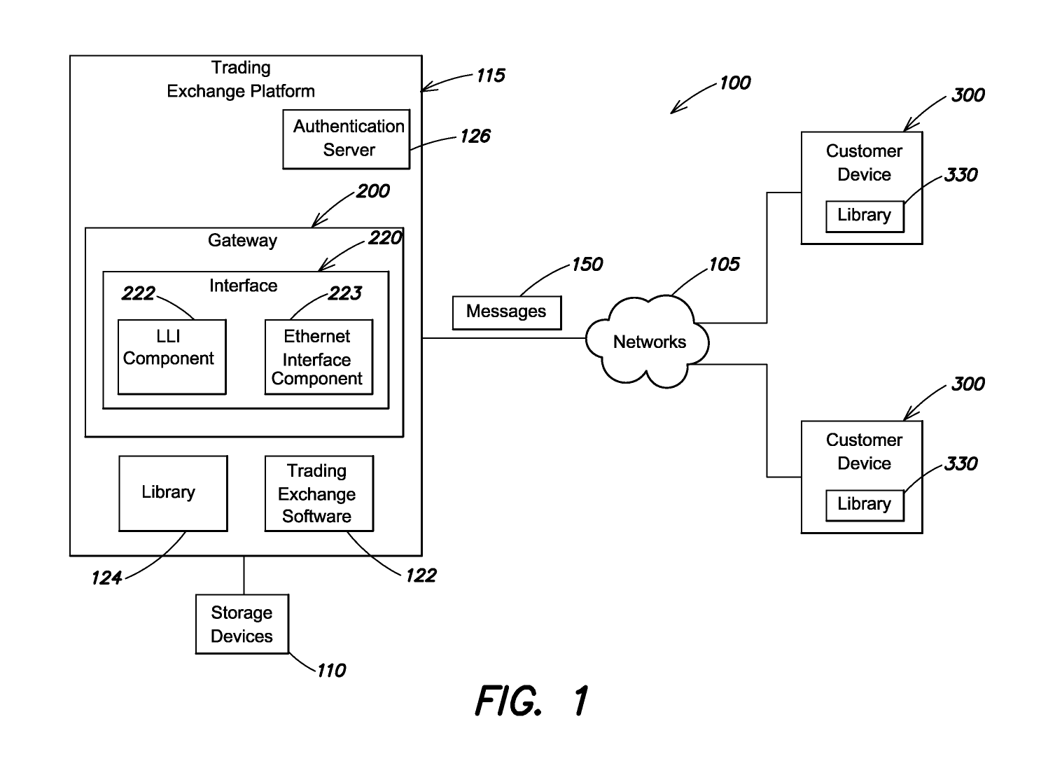

FIG. 1 illustrates a trading exchange environment 100 that may be advantageously used with the subject matter described herein. The environment 100 includes a trading exchange platform 115 that communicates with customer devices 300 over one or more networks 105, referred to herein singly and collectively as the “networks 105.” The trading exchange platform 115 is configured to operate in a manner that adheres to rules and regulations set forth by appropriate governing bodies (e.g., federal government, state government, U.S. Security and Exchanges Commission, etc.).

The trading exchange platform 115 includes a gateway 200 having an interface 220 with a low-latency interface (LLI) component 222 and an Ethernet interface component 223. The gateway 200 is discussed in more detail below. The trading exchange platform 115 also includes an authentication server 126, a library 124, and trading exchange software 122. In addition, the trading exchange platform 115 is coupled to storage devices 110 that store information utilized by the trading exchange platform 115.

In operation, the trading exchange platform 115 services requests, such as transaction requests, issued by customer devices 300 over the networks 105. For example, such transaction requests may include, but are not limited to, creating new orders (such as buying or selling stock). Illustratively, customers utilize customer devices 300 to request the services of the trading exchange platform 115 and after receipt of a request for a service, the trading exchange platform 115 utilizes trading exchange software 122 to perform the requested services in a known manner. The trading exchange platform 115 may then provide response/results, which are transmitted to the customer devices 300 over the networks 105.

The networks 105 may be, but are not limited to, an out-of-band (OOB) network and an in-band network. Typically, an OOB network is utilized for an initial session, to communicate and exchange information to perform initial functions, such as, authenticating users with the trading exchange platform 115 and initializing/establishing an authorized transaction session (e.g., over the in-band network). Once an authorized transaction session has been established between the trading exchange platform and a customer device through the gateway, most of the exchanges of information (e.g., transaction requests and responses) from that point forward typically occur during the transaction session over the in-band network. Illustratively, the in-band network offers certain advantages (e.g., greater speed, less jitter, etc.) over the OOB network. In an alternative embodiment, the OOB network and the in-band network may be the same. For example, two devices may only have a single connection between them, and thus, the single connection is utilized as the OOB network and the in-band network to both perform the initial functions during an initial session and to exchange transaction data during a transaction session.

The physical components of the networks 105 that are utilized to connect the devices are referred to herein collectively as “communication fabrics.” For example, a communication fabric may include, but is not limited to, Ethernet wires and switches (Ethernet communication fabric), or InfiniBand links and switches (InfiniBand communication fabric), or a system bus (memory bus communication fabric).

When messages 150 are exchanged over the networks 105 using a selected communication fabric, a library 330 executing on customer device 300 and a library 124 executing on the trading exchange platform 115 format the messages to conform to the syntax requirements of the communication fabric and convey the messages in accordance with the session parameters. For example, if the communication fabric being utilized over the network is the InfiniBand communication fabric, the messages 150 exchanged over the network will be formatted by the library 330 and the library 124 to conform the messages to the syntax requirements of the InfiniBand protocol. Further, bandwidth and other requirements may be associated with the transaction session, and the gateway 200 sends the messages in accordance with the associated parameters. As such, the customer devices 300 may communicate with the trading exchange platform 115 over networks 105 by exchanging messages 150 according to the pre-defined protocols associated with the communication fabric being utilized.

The storage devices 110, may be disks, and/or a database or any other physical device capable of storing information for later retrieval. For example, the storage devices may be any type of attached array of writable storage device media such as video tape, optical, DVD, magnetic tape, bubble memory, electronic random access memory, micro-electro mechanical and any other similar media adapted to store information, including data and parity information. The trading exchange platform 115 may access the storage device 110 to send/receive information to carry out transactions associated with a trading exchange, e.g., the London Stock Exchange, in a known manner.

The authentication server 126 of the trading exchange platform 115 includes processing elements and/or logic circuitry configured to authenticate the customer devices 300. Illustratively, the authentication server 126 ensures that only authorized customer devices 300 perform transactions with the trading exchange platform 115. In addition, the authentication server 126 ensures that the authorized customer devices 300 only perform allowed/permitted functions, based on the privileges granted to the customer devices 300 by the trading exchange platform 115. Illustratively, the authentication server 126 may access storage device 110 to obtain information needed to authenticate the customer devices 300.

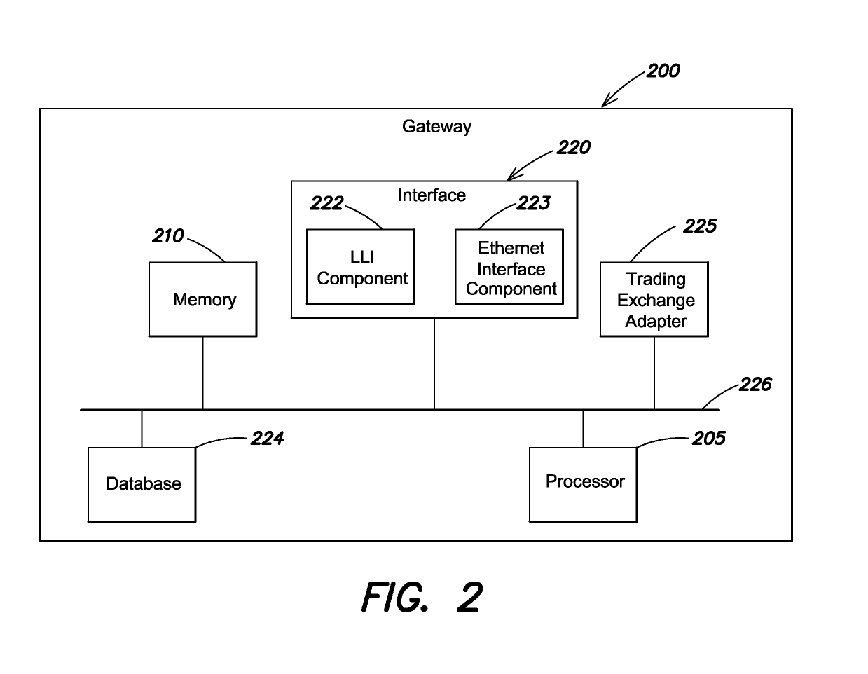

Referring now also to FIG. 2, the gateway 200 includes a processor 205, a memory 210, the interface 220 that include the LLI component 222 and the Ethernet interface component 223, a database 224, and a trading exchange adapter 225 interconnected by a system bus 226. The gateway 200 performs various functions associated with the handling of messages to/from the customer devices 300. The gateway 200 initiates the authentication process and facilitates the selection of a communication fabric for the customer devices 300, as described below. Further, the gateway 200 ensures that messages 150 from the customer devices 300 are secure and not shared with other customers or inadvertently shared with other parties. Illustratively, the gateway 200 acts essentially as a proxy between customer devices 300 and the trading exchange platform 115, so that the customer devices 300 can perform particular transactions associated with the trading exchange platform 115 in a secure manner. Illustratively, the trading exchange adapter 225 may cooperate with the trading exchange software 122 executing on the trading exchange platform 115 to perform transactions associated with the trading exchange platform 115 and, for example, to retrieve and store data on storage devices 110.

The memory 210 includes memory locations that are addressable by the processor 210, interface 220, and adapter 225, for storing and retrieving data associated with the subject matter discussed herein. The processors 205, interface 220, and adapter 225 may include processing elements and/or logic circuitry configured to execute instructions/software programs/processes, as described below. It is also expressly contemplated that the various software programs and processes described herein may be embodied as modules configured to operate in accordance with the disclosure, e.g., according to the functionality of a software program, process or layer.

The memory 210 of gateway 200 may also be directly accessed by customer device 300 over networks 105. Illustratively, particular communication fabrics (e.g., the InfiniBand communication fabric, memory bus communication fabric, or other shared memory communication fabrics) allow a device to directly access the memory of a different device using a technique that is commonly referred to as remote direct memory access (RDMA). As such, and after a session has been established, the customer device 300 may, through use of the library 330, issue RDMA messages over the networks 105 to directly access (e.g., perform read or write operations directed to) the memory 210 of the gateway 200. RDMA, as known by those skilled in the art, allows data to be transmitted from the memory of one computer to the memory of another computer without involvement of an operating system, and permits high-throughput and low-latency.

The LLI component 222 of the interface 220 allows customer devices 300 to connect to and communicate with the trading exchange platform 115 over the networks 105 through the gateway 200, utilizing a low-latency communication fabric, such as the InfiniBand communication fabric or other shared memory communication fabrics. For example, if a session is to be established over the networks 105 utilizing the InfiniBand communication fabric, the LLI component 222 of interface 220 of the gateway 200 is utilized to establish the session and subsequently exchange messages during the session. The Ethernet component 223 of the interface 220 allows customers devices 300 to connect to and communicate with the trading exchange platform 115 over the networks 105 through the gateway 200, utilizing a communication fabric that is not a low-latency communication fabric. In the example, the Ethernet component 223 provides access using the Ethernet communication fabric as well as other known communication fabrics that are not RDMA fabrics.

Database 224 stores data that may utilized by the gateway 200 to perform one or more functions as described in more detail below. Illustratively, the database 224 stores associations between the customer devices 300 and one or more of the communication fabrics available to the customer devices 300. For example, if a particular customer device 300 has the capability to connect to the trading exchange platform 115 utilizing both the InfiniBand communication fabric and the Ethernet communication fabric, the database 224 may store, within a table, a unique identifier associated with the customer device 300 and one or more other identifiers indicating, for example, that the customer device 300 has the capability to utilize both the InfiniBand and Ethernet communication fabrics as well as information relating to privileges such as bandwidth constraints, types of instruments that may be traded and so forth. Further, the database 224 may include other information related to the functionality and parameters of the communication fabrics. For example, one or more values may be stored in the database 224, and provided by an associated connection monitoring device (not shown), indicating that the particular communication fabric is not functioning at a particular time, or that the particular communication fabric is “up” and available for utilization.

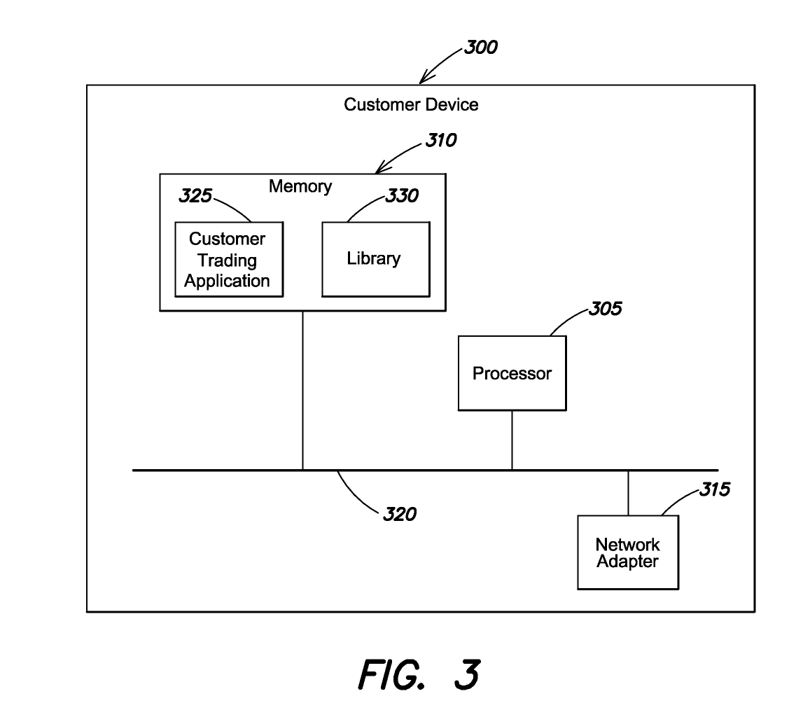

FIG. 3 is a schematic block diagram of a customer device 300 that may be advantageously used with the embodiments described herein. The customer device 300 may be a general-purpose computer that includes a processor 305, a memory 310, and a network adapter 315 interconnected by a system bus 320. The memory 310 includes memory locations that are addressable by the processor 305 and the adapter 315, and the memory 310 may store software programs and/or processes, such as a customer trading application 325 and the library 330. The customer device 300 interacts with the trading exchange platform 115 in accordance with a client/server model of information delivery. That is, the customer device 300 may connect to the trading exchange platform 115 utilizing the network adapter 315 and request the services of the trading exchange platform 115 by exchanging messages 150 over the networks 105.

Illustratively, the customer trading application 325 includes graphical user interfaces (GUIs) that include fields through which the customer provides data that is to be transmitted over the network 105 to the trading exchange platform 115. The customer trading application 325 is a universal application that can be utilized with any of a plurality of different communication fabrics, through use of the library 330. Illustratively, the library 330 is provided by the trading exchange platform 115 to be installed on customer device 300. For example, the customer device 300 may download library 330 from a website associated with the trading exchange platform 115. The library 330 provides a flexible set of classes to establish and maintain communications, over any one of a plurality of different communication fabrics, with the trading exchange platform 115 through the gateway 200.

Illustratively, the library 330 includes the information and/or data structures and/or drivers that operate with the different communication fabrics available to the customer. Specifically, the library 330 dynamically links into the customer trading application 325 to an executable routine to execute fabric specific communication sub-routines utilized to establish and maintain a transaction session between the customer device 300 and trading exchange platform 115. Thus, a customer may input data into the GUIs of the customer trading application 325 to request a particular transaction service, such as, a create order, and the library may then format that data into one or more message(s) that conform to syntax (e.g., protocol) requirements of a selected communication fabric that is being utilized. Thus, the underlying customer trading application is “universal,” in the sense that the application need not be optimized to operate with a predetermined communication fabric.

For example, once a user is authenticated and, in the example, the InfiniBand communication fabric is selected, the library 330 uses the fabric specific communication sub-routines associated with the InfiniBand communication fabric and session parameters associated with the user, to establish a transaction session that utilizes the InfiniBand communication fabric. The library 330 provides sub-routines that facilitate the formatting of messages, according to the syntax requirement of the InfiniBand communication fabric and the user-related parameters. The properly formatted messages are then sent over the network 105 to the trading exchange platform 115 through the gateway 200 utilizing the LLI component 222. Alternatively, the Ethernet communication fabric may be selected for the authenticated user, and the library 330 uses the fabric specific communication sub-routines associated with the Ethernet communication fabric and the user associated parameters to facilitate the conveyance of messages in accordance with the syntax requirements of the Ethernet communication fabric. The gateway 200 then sends the messages over the network 105 to the trading exchange platform 115 utilizing the Ethernet interface component 223.

As appropriate, the library 330 may be updated. For example, the library may be updated when the transmission requirements of a particular communication fabric are updated, or when a new communication fabric is made available to customers. The updated library may then be provided and installed on the customer devices 300, and the customer devices 300 may then operate using the new and/or updated communications fabrics, often without requiring application-level changes or even recompilation of the underlying customer trading application 325.

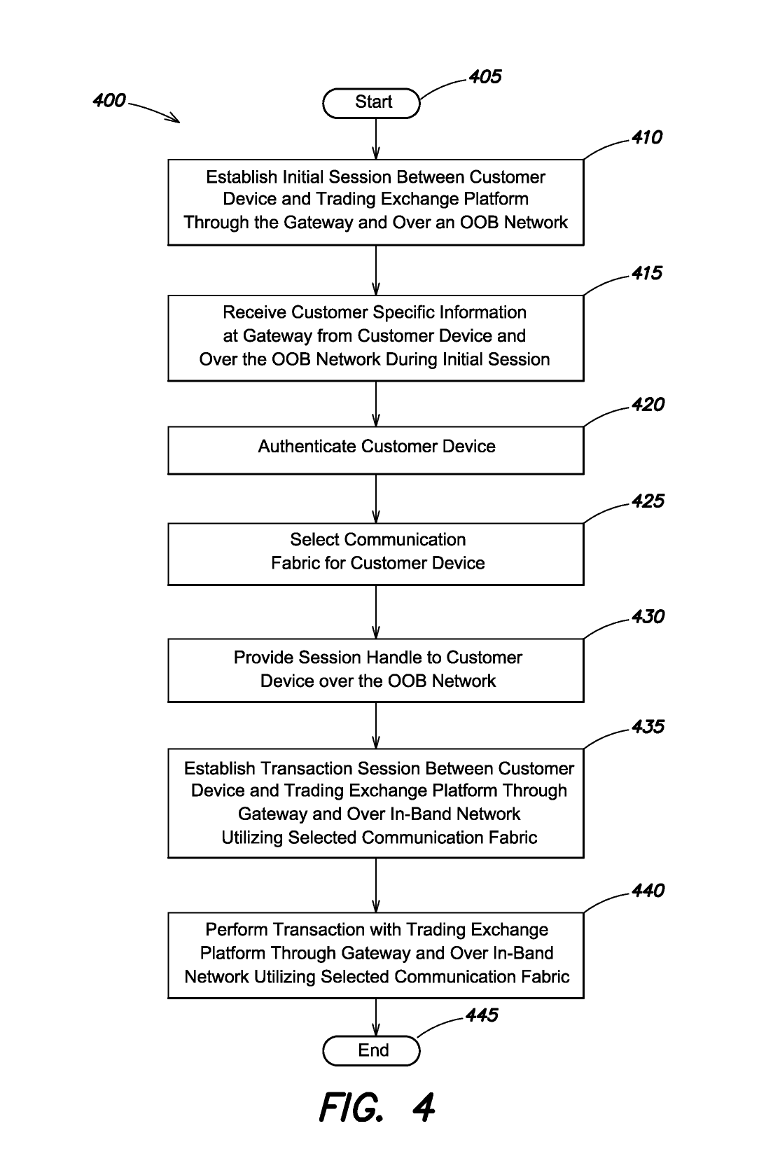

Referring now also to FIG. 4, a flowchart illustrates the steps of a procedure 400 that the system performs to dynamically select a communication fabric. The procedure 400 starts at step 405 and continues to step 410, where an initial session is established between the trading exchange platform 115 and the customer device 300 through the gateway 200 over an OOB network. Illustratively, a session object is created on the customer device 300 to establish the initial session with the trading exchange platform 115 over the OOB network through the gateway 200. As discussed, the OOB network may be associated with an Ethernet communication fabric, an InfiniBand communication fabric, memory bus communication fabric, or other shared-memory fabrics, and so forth.

If, for example, the initial session is established utilizing the Ethernet communication fabric, the customer device 300 communicates with the trading exchange platform 115 over the OOB network through the Ethernet interface component 223 of the gateway 200. Alternatively, if the initial session is established utilizing the InfiniBand communication fabric, the customer device 300 communicates with the trading exchange platform 115 over the OOB network through the LLI component 222 of the gateway 200. It is noted that the initial session may be established over the OOB network in a manner that is transparent to the customer trading application 325 of the customer device 300, which utilizes the library 330.

The procedure continues to step 415, where customer specific information is received at the gateway 200 of the trading exchange platform 115, from the customer device 300 over the OOB network. For example, the customer may input the customer specific information using the customer trading application 325 executing on the customer device 300. The library 330 executing on the customer device 300 may then format messages, which contain the customer specific information, according to syntax requirements of the communication fabric being utilized during the initial session over the OOB network. The formatted messages, which include the customer specific information, are then sent to the gateway 200 over the OOB network. Such customer specific information may include, but is not limited to, a username, password, credentials, rights, etc.

The procedure continues to step 420, where the customer device 300 is authenticated. Illustratively, the gateway 200 provides the customer specific information received from the customer device 300 during the initial session to the authentication server 126, which operates in a known manner to determine if the customer is an authorized user. For example, the authentication server 126 may compare the customer supplied information (e.g., a username and a password) with stored information (e.g., on storage devices 110) to ensure that the customer device 300 is authorized to access the trading exchange platform 115. The authentication server 126 may then authenticate the customer device 300.

The procedure continues to step 425, where a communication fabric is selected for the customer device 300. Illustratively, the customer device 300 may have the capability to connect to the trading exchange platform 115, through the gateway 200 and during a transaction session, over an in-band network utilizing one of a plurality of different communication fabrics, such as InfiniBand communication fabric, Ethernet communication fabric, memory bus communication fabric, etc. The gateway 200 may utilize the received customer specific information (e.g., username and password) to query the database 224 to determine the different communication fabrics available to the customer device 300. Based on the query of the database 224, the gateway 200 may then select a communication fabric for the customer device 300 so that a transaction session can be established over an in-band network utilizing the selected communication fabric. For example, the gateway 200 may select the InfiniBand communication fabric, based on a determination that the InfiniBand communication fabric is the “best” communication fabric (e.g., fastest, most reliable) available to the customer device 300 at the time of user authentication. Alternatively, if the gateway determines that the InfiniBand communication fabric is “down” (based on a heartbeat message not being received from a connection monitoring device) or “slow” (based on bandwidth computation data), the gateway 200 may select a different communication fabric, such as the Ethernet communication fabric or the memory bus communication fabric for the customer device 300.

The procedure continues to step 430 where the gateway 200 provides a session handle to the customer device 300 over the OOB network to establish a transaction session over an in-band network utilizing the selected communication fabric. Illustratively, the session handle includes information, such as an identifier associated with the selected communication fabric and/or for RDMA communication fabrics associated memory addresses. The session handle may also include various other parameters associated with the establishment of the transaction session over the selected communication fabric, such as associated privileges and so forth. The procedure continues to step 435, where the transaction session is established between the trading exchange platform 115 and the customer device 300 through the gateway 200 over the in-band network utilizing the selected communication fabric. Illustratively, if the selected communication fabric is a low-latency communication fabric, the transaction session is established utilizing the LLI component 222 of the gateway 200. Alternatively, if the selected communication fabric is not a low-latency fabric (e.g., Ethernet communication fabric), the transaction session is established utilizing the Ethernet interface component 223 of the gateway 200. It is noted that the transaction session is established over the in-band network in a manner that is transparent to the user of the customer device 300.

Illustratively, the library 330 executing on the customer device 300 communicates with the gateway 200 to establish the transaction session over the in-band network utilizing the selected communication fabric. Specifically, the library 330 dynamically links into the customer trading application 325 to an executable routine to execute fabric specific communication sub-routines utilized to establish the transaction session with the trading exchange platform 115 over the in-band network. For example, a negotiation/handshaking process occurs between the library 330 (utilizing the fabric specific communication sub-routines) and the trading exchange platform 115 through the gateway 200 to establish the transaction session over the in-band network utilizing the selected communication fabric.

The procedure continues to step 440, where the customer device 300, during the transaction session, performs a transaction with the trading exchange platform 115 through the gateway 200 and over the in-band network utilizing the selected communication fabric. If the selected communication fabric is the InfiniBand communication fabric, for example, the customer device 300 through use of the library 330 sends RDMA messages over the in-band network to write/read data directly to/from the memory addresses of the gateway 200 utilizing the LLI component 222. For example, if the customer device 300 wants to create a new order and send the new order to the trading exchange platform 115, the library 330 of the customer device 300 may utilize a write operation to directly write data associated with new order to the memory locations of the gateway 200 that are assigned to the transaction session. Specifically, the customer may input the transaction data into fields of one or more GUI interfaces of the customer trading application 325, and the library 330 executing on the customer device 300 may format the transaction data into messages according to syntax requirements of the InfiniBand communication fabric. The formatted messages may then be sent over the in-band network through the LLI component 222 of the gateway 200 to write directly to the memory 210 of the gateway 200 in accordance with the bandwidth and other parameters associated with the transaction session.

Alternatively, if the selected communication fabric is not a low-latency communication fabric, the customer device 300 through use of the library 330 transmits messages to the trading exchange platform 115 through the gateway 200 utilizing the Ethernet interface component 223. Thus, the transaction session in a known manner transparently abstracts the serialization and conveyance of the request over the selected communication fabric utilizing the client side library 330.

The gateway 200 may transmit or provide the transaction data to the trading exchange software 122 of the trading exchange platform 115, to further carry out the transaction. Moreover, the gateway 200 may send one or more responses to the customer device 300 during the transaction session over the in-band network indicating a status of the transaction, as appropriate. For example, the responses may be displayed through the customer trading application 325 executing on the customer device 300. At step 445, the procedure ends.

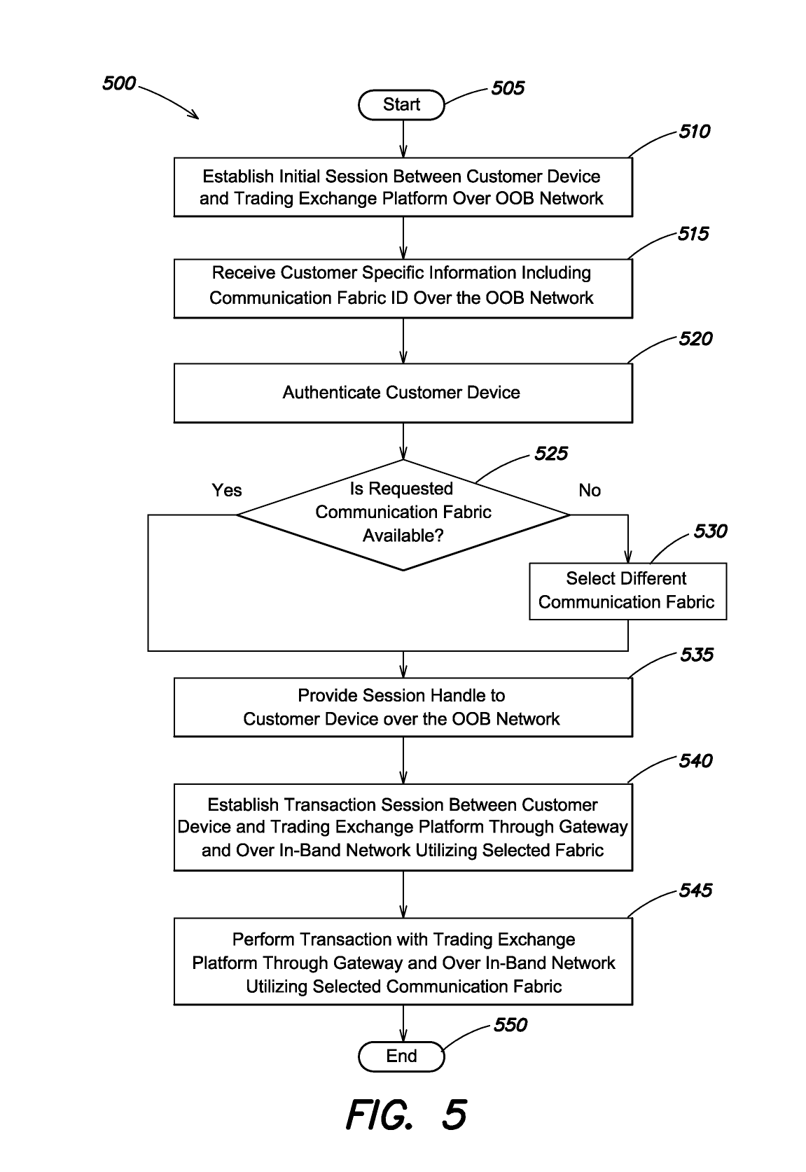

Referring now to FIG. 5, a flowchart illustrates the steps of a procedure 500 that the system performs to dynamically select a communication fabric for a customer requesting a particular fabric. The procedure 500 starts at step 505 and continues to step 510, where an initial session is established between the trading exchange platform 115 and the customer device 300 through the gateway 200 over an OOB network. Illustratively, a session object is created on the customer device 300 to establish the initial session over the OOB network. The procedure continues to step 515, where customer specific information including a communication fabric identifier is received at the gateway 200 from the customer device 300. The customer specific information may further include, but is not limited to, a username, password, credentials, rights, etc. The included communication fabric identifier may be associated with one of a plurality of communication fabrics available to the customer device 300 to utilize to communicate with the trading exchange platform 115.

Illustratively, the library 330 executing on the customer device 300 formats messages that contain the customer specific information according to syntax requirements of the communication fabric being utilized during the initial session over the OOB network. The formatted messages are then transmitted over the OOB network to the trading exchange platform 115 through the gateway 200 utilizing either the LLI component 222 or the Ethernet interface component 223, as appropriate.

The procedure continues to step 520, where the customer device 300 is authenticated. For example, the gateway 200 provides the customer specific information to the authentication server 126, which operates in a known manner to authenticate the customer device 300.

The procedure continues to step 525, where it is determined by the gateway 200 whether or not the communication fabric requested by the customer device 300 is then available to establish a transaction session over the in-band network. Illustratively, the customer device 300 may have the capability to connect to the trading exchange platform 115, through the gateway 200, over an in-band network utilizing one of a plurality of different communication fabrics, such as InfiniBand communication fabric, Ethernet communication fabric, memory bus communication fabric, etc. The gateway 200 may utilize the received customer specific information (e.g., username and password) to query the database 224 to determine if the customer device 300 has the requisite privileges to utilize the requested communication fabric, and also whether or not the requested communication fabric is then operating in a reliable manner, i.e., whether or not the communication fabric is up. If at step 525 it is determined that the requested communication fabric is not available to the customer device 300 and/or is unreliable, the procedure continues to step 530 and the gateway 200 selects a different communication fabric for the transaction session. For example, the customer device 300 may request to utilize the InfiniBand communication fabric during the transaction session and the gateway 200 may determine that the InfiniBand communication fabric is down or that the customer device 300 does not have the requisite privilege to use the InfiniBand communication fabric. The gateway 200 may then, for example, select the Ethernet communication fabric as the communication fabric to be utilized by the customer device 300 for the transaction session. If at step 525, it is determined that the requested communication fabric is available to the customer device 300 and/or then reliable, the request for the communication fabric is granted and the requested communication fabric is selected for the transaction session.

At step 535, the gateway 200 provides a session handle to the customer device 300 over the OOB network. Illustratively, the session handle includes information, such as an identifier associated with the selected communication fabric and/or for RDMA communication fabrics associated memory addresses. The procedure continues to step 540, where a transaction session is established between the customer device 300 and the trading exchange platform 115 through the gateway 200 and over the in-band network utilizing the selected communication fabric. Illustratively, if the selected communication fabric is a low-latency communication fabric, the transaction session is established utilizing the LLI component 222 of the gateway 200. Alternatively, if the selected communication fabric is not a low-latency communication fabric (e.g., Ethernet communication fabric), the transaction session is established utilizing the Ethernet interface component 223 of the gateway 200.

Illustratively, the library 330 executing on the customer device 300 communicates with the gateway 200 to establish the transaction session over the in-band network utilizing the selected communication fabric. Specifically, the library 330 dynamically links into the customer trading application 325 to an executable routine to execute fabric specific communication sub-routines utilized to establish the transaction session with the trading exchange platform 115 over the in-band network.

The procedure continues to step 545, where the customer device 300, during the transaction session, requests transaction services from the trading exchange platform 115 through the gateway 200 and over the in-band network utilizing the selected communication fabric. For example, if the selected communication fabric is a low-latency communication fabric, the customer device 300 transmits messages (formatted by the library 330 to conform to the syntax requirements of the low-latency communication fabric) over the in-band network to write directly to the memory location of the gateway 200 through the LLI component 222. Alternatively, if the selected communication fabric is not a low-latency communication fabric, the customer device 300 transmits messages (formatted by the library 330 to conform to the syntax requirements of the communication fabric that is not an RDMA communication fabric) over the in-band network through the Ethernet interface component 223. As discussed above, reply messages, status messages, and so forth that are part of the requested transaction service are provided to the customer device 300 over the selected communication fabric through the gateway 200. At step 550, the procedure ends.

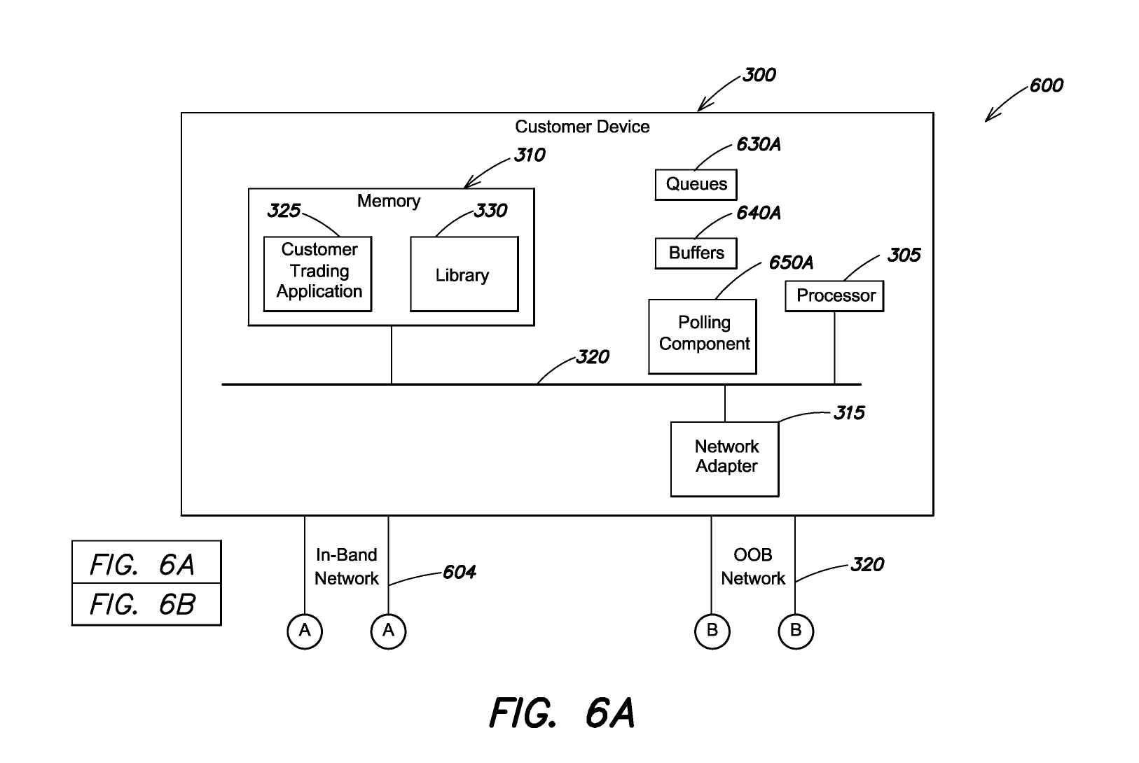

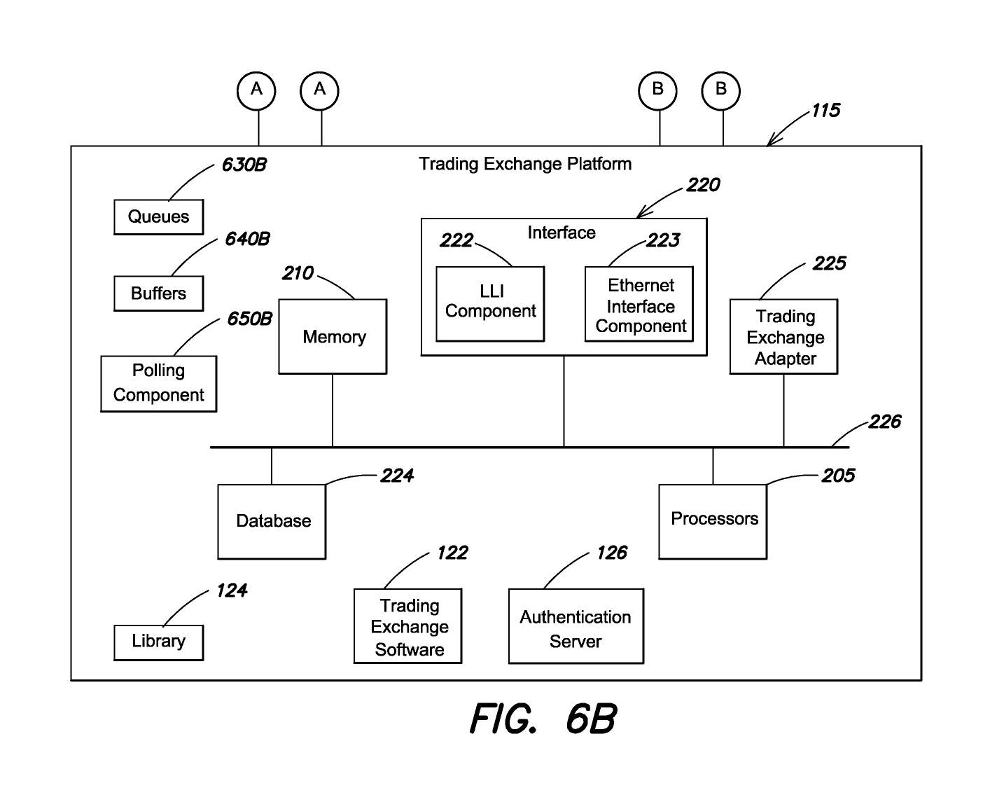

FIGS. 6A and 6B illustrate a trading exchange environment 600 that may be advantageously used with the subject matter described herein. The environment 600 includes a trading exchange platform 115 that communicates with the customer device 300 over an OOB network 602 and an in-band network 604. The in-band network 604 is illustratively a direct memory transport with RDMA capabilities. A direct memory transport has asynchronous send and receive capabilities that utilize switches to establish point-to-point connections between the customer device 300 and the trading exchange platform 115, such that data flows directly between the customer device 300 and the gateway 200, and from the gateway 200 to the trading exchange platform 115.

In addition, the customer device 300 and trading exchange platform 115 respectively include queues 630A and 630B, buffers 640A and 640B, and polling components 650A and 650B that are utilized in a known manner for sending data to memory regions that are associated with endpoints of the transaction session and that are assigned when the transaction session is established over the in-band network. The buffers, queues, and polling components provide the asynchronous sending and receiving of data, while the associated memory regions provide the privacy of the data.

Illustratively, the customer device 300 provides customer specific information to the trading exchange platform 115 through the gateway 200 and over the OOB network 602 during an initial session utilizing the customer trading application 325. In a particular embodiment, the OOB 602 utilizes a communication fabric that is not low-latency, such as the Ethernet communication fabric. As such, the library 330 executing on the customer device 300 formats messages that contain the customer specific information to conform the messages to syntax requirements of the communication fabric utilized for OOB communications. The formatted messages are then transmitted, over the OOB network 602 to the gateway 200 utilizing the Ethernet interface component 223 of interface 220. In addition, the respective queues 630A and 630B and buffers 640A and 640B on the trading exchange platform 115 and customer device 300 may be utilized in a known manner, as needed, to support the sending and receiving of the customer specific information over the OOB network.

The gateway 200 may then transmit or provide the customer specific information to the authentication server 126 that operates in a known manner to authenticate the customer device 300. Further, the gateway 200 may use the customer specific information to query the database 224 to select, for use during the transaction session, one of a plurality of communication fabrics available to the customer device 300. Illustratively, the selected communication fabric is a low-latency communication fabric, such as the InfiniBand communication fabric. The gateway 200 then sends back to the customer device 300 over the OOB network 602 a session handle that includes a communication fabric identifier associated with the selected communication fabric and memory addresses of the gateway 200 that are assigned to the transaction session.

A transaction session is then established between the customer device 300 and trading exchange platform 115 over the in-band network 604 utilizing the selected low-latency communication fabric. In the example, the low-latency communication fabric is a RDMA fabric. Thus, a negotiation/handshaking process occurs between the library 330 (utilizing fabric specific communication sub-routines associated with the selected low latency communication fabric) and the trading exchange platform 115 through the LLI component 222 of the gateway 200 to establish the transaction session over the in-band network 604 utilizing the selected communication fabric.

Once the transaction session is established over the in-band network 604 utilizing the low-latency communication fabric, the library 330 and library 124 format the messages according to the syntax requirements of the low-latency communication fabric. The messages, in the form of RDMA messages, may then be sent over in-band network 604 asynchronously to memory locations of memory 210 of gateway 200 utilizing LLI component 222 of interface 220. In addition, the respective queues 630A and 630B, buffers 640A and 640B, and polling components 650A and 650B on the trading exchange platform 115 and customer device 300 may be utilized to perform the functions associated with sending and receiving the transaction data.

The foregoing description has been directed to specific subject matter. It will be apparent, however, that other variations and modifications may be made to the described subject matter, with the attainment of some or all of its advantages. It is expressly contemplated that the procedures, processes, and methods described herein may be implemented in alternative orders. For example, although reference is made to the InfiniBand communication fabric, Ethernet communication fabric, and memory bus communication fabric, any other communication fabric or medium may be utilized. Further, although the memory and processor and other components of the trading exchange platform are resident in the gateway, it is expressly contemplated that the components may be resident on the trading exchange platform independent of the gateway. Accordingly this description is to be taken only by way of example and not to otherwise limit the scope of the subject matter described herein. Therefore, it is the object of the appended claims to cover all such variations and modifications as come within the true spirit and scope of the subject matter.

What is claimed is:

1. A system for dynamically selecting a communication fabric, comprising:
a gateway, of a trading exchange platform, having a processor and a memory, the gateway configured to:
receive, over an out-of-band network, customer specific information from a customer device configured to request services of the trading exchange platform;
utilize the customer specific information to select a communication fabric from a plurality of communication fabrics available for use during a transaction session to provide the requested services; and
receive from the customer device, over an in-band network utilizing the selected communication fabric, transaction data associated with one or more transactions to be performed by the trading exchange platform during the transaction session.

2. The system of claim 1, wherein the selected communication fabric is one of an Ethernet communication fabric, an InfiniBand communication fabric, and a memory bus communication fabric.

3. The system of claim 1, wherein the transaction data is received in remote direct memory access (RDMA) messages, from the customer device, to directly write the transaction data to the memory of the gateway.

4. The system of claim 1, wherein the customer specific information includes at least one of: a username, a password, credentials, privileges, and a communication fabric identifier.

5. The system of claim 4, wherein the customer specific information is utilized to authenticate the customer device and to determine that the customer device is authorized to interact with the trading exchange platform.

6. The system of claim 1, wherein the gateway is further configured to transmit a session handle to the customer device over the OOB network, the session handle including at least one of memory address locations of the memory and a communication fabric identifier associated with the selected communication fabric.

7. The system of claim 1, wherein the gateway is configured to communicate with a library installed on the customer device to establish the transaction session over the in-band network utilizing the selected communication fabric.

8. The system of claim 1, wherein the out-of-band network and the in-band network utilize different communication fabrics.

9. The system of claim 1, wherein the out-of-band network and the in-band network utilize the same communication fabrics.

10. The system of claim 1, wherein the one or more transactions include creating a new order.

11. A method for dynamically selecting a communication fabric, comprising:
receiving, at a gateway of a trading exchange platform and over an out-of-band network, customer specific information from a customer device configured to request services of the trading exchange platform, the gateway including a process and a memory;
utilizing the customer specific information to select a communication fabric from a plurality of communication fabrics available for use during a transaction session to provide the requested services; and
receiving from the customer device, over an in-band network utilizing the selected communication fabric, transaction data associated with one or more transactions to be performed by the trading exchange platform during the transaction session.

12. The method of claim 11, wherein the selected communication fabric is one of an Ethernet communication fabric, an InfiniBand communication fabric, and a memory bus communication fabric.

13. The method of claim 11, wherein the transaction data is received in remote direct memory access (RDMA) messages, from the customer device, to directly write the transaction data to the memory of the gateway.

14. The method of claim 11, wherein the customer specific information includes at least one of: a username, a password, credentials, privileges, and a communication fabric identifier.

15. The method of claim 11 further comprising utilizing the customer specific information to authenticate the customer device and to determine that the customer device is authorized to interact with the trading exchange platform.

16. The method of claim 11 further comprising transmitting a session handle to the customer device over the OOB network, the session handle including at least one of memory address locations of the memory and a communication fabric identifier associated with the selected communication fabric.

17. The method of claim 11 further comprising communicating with a library installed on the customer device to establish the transaction session over the in-band network utilizing the selected communication fabric.

18. The method of claim 11, wherein the out-of-band network and the in-band network utilize different communication fabrics.

19. The method of claim 11, wherein the out-of-band network and the in-band network utilize the same communication fabrics.

20. The method of claim 11, wherein the one or more transactions include creating a new order.
